(19) United States
(12) Patent Application Publication
(10) Pub. No.: US 2010/0290536 A1
(43) Pub. Date: Nov. 18, 2010

(54) MOVING IMAGE TRANSMISSION/RECEPTION SYSTEM

(76) Inventors: Kenji Iwahashi, Osaka (JP); Yoshiaki Mimata, Osaka (JP); Tomokazu Uchida, Osaka (JP)

Correspondence Address: MCDERMOTT WILL & EMERY LLP, 600 13TH STREET, NW, WASHINGTON, DC, 20005-3096, US

(21) Appl. No.: 12/808,554

(22) PCT Filed: Dec. 1, 2008
(86) PCT No.: PCT/JP2008/003539

§ 371 Date: Jun. 16, 2010

(30) Foreign Application Priority Data
Jan. 24, 2008 (JP) 2008-013389

(51) Int. Cl. H04N 7/24; G06K 9/36; H04N 7/26

(52) U.S. Cl. 375/240.25; 382/233; 375/E07.021; 375/E07.026

(57) ABSTRACT

An image transmission device (101) includes: an encoding section (102) configured to retrieve and encode image data and output encoded data in one frame in predetermined units; a padding section (107) configured to add padding so that the size of data output from the encoding section (102) matches a predetermined size; a packet processing section (103) configured to perform packetization upon completion of padding addition by the padding section (107); and a memory (105) configured to hold encoded data and packet data. An image reception device (201) includes: a depacketizing section (202, 203) configured to receive a packet from the image transmission device (101) and depacketize the packet; and a decoding section (204) configured to decode compressed data in predetermined units and output a stream.

### TECHNICAL FIELD

The present invention relates to a transmission/reception system that performs low-delay transmission of a moving image stream on a network.

### BACKGROUND ART

In conventional moving image transmission/reception systems, recently, international standards for compression of moving image signals, such as MPEG-2 and H.264,have been established as moving image compression technology. Media information such as video and audio (hereinafter referred to as multimedia information) is generated concurrently. To transmit multimedia information via a communication channel and reproduce the information on the receiver side, such information must be multiplexed into one stream together with synchronization information. One of international standards for implementing such multiplexing is Transport Stream (TS). In TS, encoded media information is packetized in appropriate units for each medium, to form variable-length packetized elementary stream (PES) packets. The PES packets are then divided into fixed-length TS packets, and then multiplexed.

To form and transmit one TS packet, it is necessary to prepare a set of encoded data required to constitute one TS packet. Therefore, in low bit rate encoding, in particular, processing delay in packetization raises a problem. To reduce this processing delay, a multiplexing method is conventionally adopted, in which redundant data (stuffing data) of the same amount as the shortage of data required to form one TS packet is inserted in the multiplexing layer, to constitute one TS packet together with encoded data. However, since stuffing data is irrelevant of the original media information, it is desirable to minimize insertion of such stuffing data in the TS packet to be transmitted. To attain this, a method has been proposed in which the PES packet length is fixed and the fixed length is set at an integer multiple of the size of the payload of the TS packet (see Patent Document 1, for example).

However, in the method described above, in which the PES packet length is fixed, a set of ES data required to form a TS packet may not be prepared, failing to send the TS packet.

To solve the above problem, there is a method in which whether the amount of media information data encoded at given time intervals is a packetizable data amount is monitored (see Patent Document 2). By this method, encoded media information can be held until a size of encoded media information required for packetization has been prepared and packetized once the size required has been prepared. Thus, the problem of failing to send a packet because of failing to prepare a set of encoded media information is avoided. There is also a method in which, in the monitoring of the packet size, if it is detected that a predetermined data size of media information has not been prepared, adjustment is made by stuffing the packet to obtain the predetermined data size.

### Citation List

PATENT DOCUMENT 1: Japanese Patent Publication No. P2003-108194

PATENT DOCUMENT 2: Japanese Patent Publication No. P2005-101860

### SUMMARY OF THE INVENTION

### Technical Problem

However, in the conventional moving image transmission/reception systems, since stuffing data is inserted at the time of packetization, the stuffing data must be removed on the receiver side. Data can be decoded only when one frame of encoded data has been received. Therefore, it takes time to decode data after reception of the data. In the case of monitoring encoded media information at given periods, the monitoring load will increase when the period is short. Conversely, when the period is long, the transmission delay will not be sufficiently reduced. Therefore, adjustment to the most efficient state is difficult.

### Solution to the Problem

The moving image transmission/reception system of the present invention includes: an image transmission device; and an image reception device, wherein the image transmission device includes an encoding section configured to capture and encode image data and output encoded data in one frame in predetermined units, a padding section configured to add padding so that the size of data output from the encoding section matches a predetermined size, a packet processing section configured to perform packetization upon completion of padding addition by the padding section, a network transmission section configured to transmit data packetized by the packet processing section via a network, and a memory configured to hold encoded data and packet data, and the image reception device includes a network reception section configured to receive a packet from the image transmission device, a depacketizing section configured to depacketize the packet received by the network reception section, and a decoding section configured to decode compressed data in predetermined units and output a stream.

In the moving image transmission/reception system described above, the predetermined unit in the encoding section may be a NAL unit under H.264, a video packet under MPEG-4, or a slice under MPEG-2.

According to the moving image transmission/reception system described above, padding can be added in step with a predetermined unit for packetization, which is a unit smaller than one frame.

In the moving image transmission/reception system described above, the packetization by the packet processing section may be processing of a PES packet and a TS packet, or network packet processing.

According to the moving image transmission/reception system described above, stuffing during the packet processing can be omitted, and thus decodable packet data can be transmitted before generation of one frame of encoded data.

In the moving image transmission/reception system described above, in depacketizing and decoding of a received packet, the image reception device may decode the packet with padding data added thereto without deleting the padding data.

In the moving image transmission/reception system described above, the predetermined unit in the decoding section may be a NAL unit under H.264, a video packet under MPEG-4, or a slice under MPEG-2.

In the moving image transmission/reception system described above, deletion of padding can be omitted in the decoding processing, and decoding can be made by a unit smaller than one frame. Thus, low-delay processing of data can be achieved.

### ADVANTAGES OF THE INVENTION

In the moving image transmission/reception system of the present invention, data is packetized by a decodable unit that is smaller than one frame, and invalid padding data is added to the data before the packetization. The invalid padding data can be left unremoved during decoding, and thus stuffing deletion processing can be omitted on the receiver side. Also, since decoding can be made by a unit smaller than one frame, it is possible to achieve low-delay processing from transmission of encoded data until decoding of received data via a network.

### BRIEF DESCRIPTION OF THE DRAWINGS

FIG. 1 is a block diagram of a moving image transmission/reception system of an embodiment of the present invention.

FIG. 2 is a flowchart of transmission processing of an image transmission device 101 shown in FIG. 1.

FIG. 3 is a flowchart of reception processing of an image reception device 201 shown in FIG. 1.

### DESCRIPTION OF REFERENCE CHARACTERS

101 Image Transmission Device

102 Encoding Processing Section

103 Packet Processing Section

104 Network Transmission Section

105 Storage Section

106 Encoding Section

107 Padding Section

108 PES Packet Processing Section

109 TS Packet Processing Section

110 Network Packet Processing Section

201 Image Reception Device

202 Network Reception Section

203 Depacketizing Section

204 Decoding Section

205 Network Depacketizing Section

206 TS Depacketizing Section

207 Storage Section

### DESCRIPTION OF EMBODIMENTS

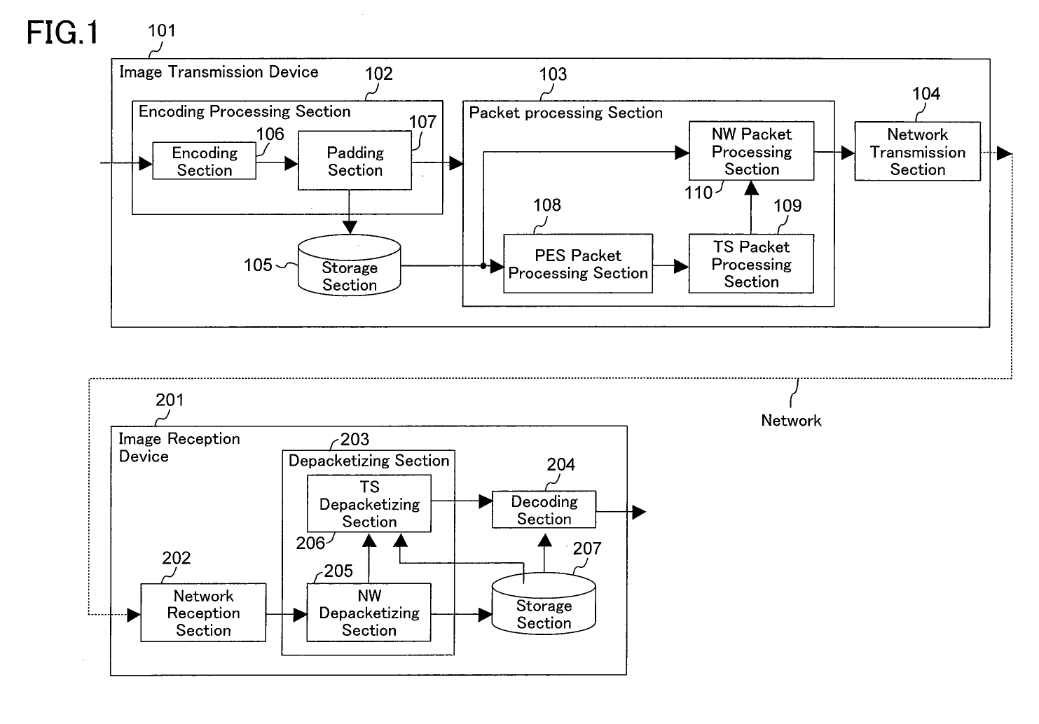

FIG. 1 is a block diagram of a moving image transmission/reception system of an embodiment of the present invention. This system includes an image transmission device 101 and an image reception device 201. The image transmission device 101 transmits media information to the image reception device 201 via a network. The image reception device 201 receives media information transmitted from the image transmission device 101 via the network.

The image transmission device 101 includes: an encoding processing section 102 that captures video information, encodes the video information under H.264 in NAL units, and outputs the encoded data with padding data added thereto so that the encoded data size matches a predetermined size unit for packetization; a packet processing section 103 that is notified of data in NAL units by the encoding processing section 102 and packetizes the data; a network transmission section 104 that transmits the packetized data via the network; and a storage section (memory) 105 that holds encoded data and packet data.

The encoding processing section 102 includes: an encoding section 106 that captures video information and encodes the video information under H.264 in NAL units; and a padding section 107 that adds padding data to the encoded data so that the encoded data size matches a predetermined size unit for packetization.

The packet processing section 103 includes: a PES packet processing section 108 that packetizes data into PES packets; a TS packet processing section 109 that packetizes PES packets into TS packets; and a network packet processing section 110 that packetizes a plurality of TS packets into a network transmission packet.

The image reception device 201 includes: a network reception section 202 that outputs a network packet received via the network; a depacketizing section 203 that depacketizes the network packet and then depacketizes TS packets; and a decoding section 204 that decodes depacketized NAL units.

The depacketizing section 203 includes: a network depacketizing section 205 that depacketizes a network packet; and a TS depacketizing section 206 that depacketizes a TS packet.

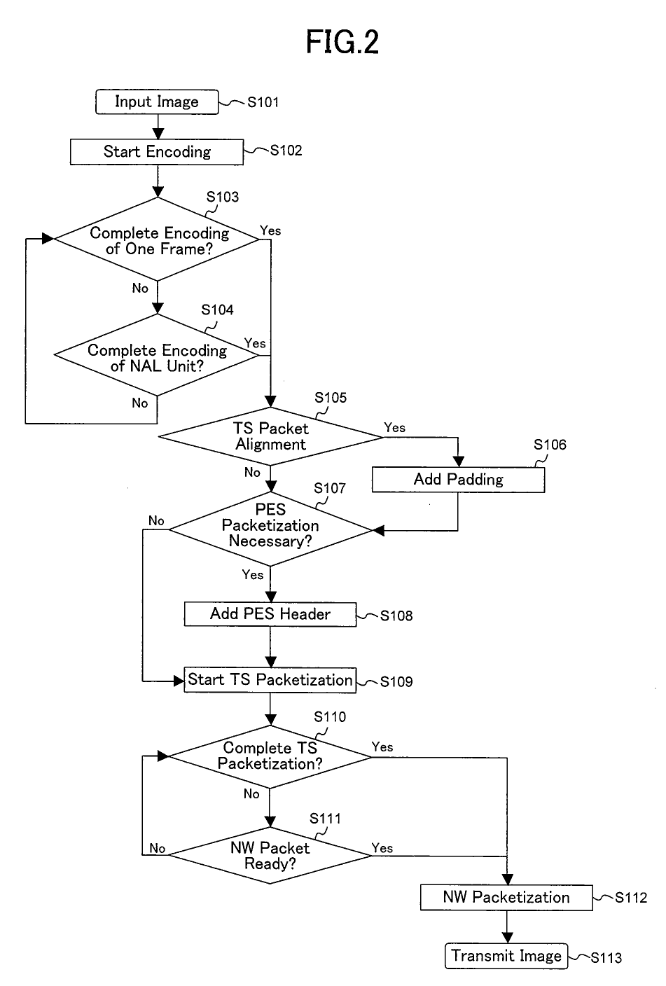

FIG. 2 is a flowchart showing a flow of transmission processing of media information by the image transmission device 101 shown in FIG. 1. The processing will be described with reference to FIG. 2.

In step S101, video information is input from outside. The video information is encoded under H.264 in NAL units in the encoding section 106 (step S102). Whether or not encoding of one frame has been completed is then determined in step S103. The process proceeds to step S104 if one-frame encoding has not been completed, or proceeds to step S105 if it has been completed. In the step S104, whether or not encoding of one NAL unit has been completed is determined. The process proceeds to step S105 if encoding of one NAL unit has been completed, or returns to the step S103 if it has not been completed. In the step S105, whether or not packet alignment is necessary is determined. More specifically, if the encoded data amount matches a TS packet size unit, it is determined that packet alignment is unnecessary, and the process proceeds to step S107. If the encoded data amount does not match the TS packet size unit, it is determined that packet alignment is necessary, and the process proceeds to step S106. In the step S106, H.264 invalid data “00” is added as padding data so that the data amount matches the TS packet size unit in the padding section 107.

With notification of completion of encoding of one NAL unit by the encoding section 106, whether or not PES packetizing is necessary is determined in step S107. If the NAL unit corresponds to the head of a frame, it is determined that PES packetizing is necessary, and the process proceeds to step S108. If the NAL unit corresponds to a portion after a PES packet or a portion other than the head of a frame, it is determined that PES packetizing is unnecessary, and the process proceeds to step S109. In the step S108, a PES packet (header) is added in the PES packet processing section 108. In the step S109, TS packetizing is performed in the TS packet processing section 109.

In step S110, whether or not the TS packetizing has been completed is determined. If completed, the process proceeds to step S112. If not completed, the process proceeds to step S111. In the step S111, whether or not the TS-packetized data amount is equal to or more than the size of a network packet is determined. If yes, the process proceeds to the step S112. If no, the process returns to the step S110. In the step S112, network packetizing is performed in the network packet processing section 110, and the resultant network packet data is delivered via the network in the network transmission section 104.

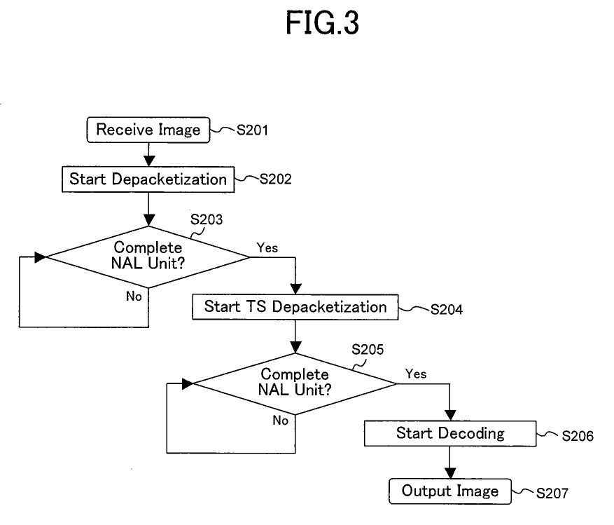

FIG. 3 is a flowchart showing a flow of reception processing of media information by the image reception device 201 shown in FIG. 1. The processing will be described with reference to FIG. 3.

The network packet data delivered from the image transmission device 101 via the network is received in the network reception section 202 (step S201). The received network packet is depacketized in the network depacketizing section 205 (step S202). In step S203, whether or not depacketization of the network packet has been completed for a NAL unit is determined. If completed, the process proceeds to step S204, in which each TS packet is depacketized in the TS depacketizing section 206, to retrieve encoded data. In step S205, whether or not the amount of the encoded data is equal to or more than the amount of the NAL unit is determined. If yes, the process proceeds to step S206, in which the encoded data is decoded in the decoding section 204 and output. This encoded data includes the padding data added in the transmission device 101.

The codec in the above embodiment may be operated, not only in NAL units under H.264, but also in video packets under MPEG-4 or in slices under MPEG-2.

In the packetization processing in the above embodiment, the processing may be performed per network packet even when ES data is delivered via a network without being subjected to PES packetizing or TS packetizing.

The processing in the above embodiment may also be implemented by software using a CPU.

As described above, the media information processing method described in the above embodiment can be used for any of equipment and systems described above.

### INDUSTRIAL APPLICABILITY

As described above, the moving image transmission/reception system of the present invention has the advantage of allowing low-delay delivery of moving image encoded data via a network, and thus is useful for network cameras and the like.

1. A moving image transmission/reception system comprising:
an image transmission device; and
an image reception device,
wherein
the image transmission device includes
an encoding section configured to capture and encode image data and output encoded data in one frame in predetermined units,
a padding section configured to add padding so that the size of data output from the encoding section matches a predetermined size,
a packet processing section configured to perform packetization upon completion of padding addition by the padding section,
a network transmission section configured to transmit data packetized by the packet processing section via a network, and
a memory configured to hold encoded data and packet data, and the image reception device includes
a network reception section configured to receive a packet from the image transmission device,
a depacketizing section configured to depacketize the packet received by the network reception section, and
a decoding section configured to decode compressed data in predetermined units and output a stream.

2. The system of claim 1, wherein
the predetermined unit in the encoding section is a NAL unit under H.264.

3. The system of claim 1, wherein
the predetermined unit in the encoding section is a video packet under MPEG-4.

4. The system of claim 1, wherein
the predetermined unit in the encoding section is a slice under MPEG-2.

5. The system of claim 1, wherein
the packetization by the packet processing section is processing of a PES packet and a TS packet.

6. The system of claim 1, wherein
the packetization by the packet processing section is network packet processing.

7. The system of claim 1, wherein
in depacketizing and decoding of a received packet, the image reception device decodes the packet with padding data added thereto without deleting the padding data.

8. The system of claim 1, wherein
the predetermined unit in the decoding section is a NAL unit under H.264.

9. The system of claim 1, wherein
the predetermined unit in the decoding section is a video packet under MPEG-4.

10. The system of claim 1, wherein
the predetermined unit in the decoding section is a slice under MPEG-2.
